(19) United States
(12) Patent Application Publication
(10) Pub. No.: US 2017/0171566 A1
(43) Pub. Date: Jun. 15, 2017

(54) METHOD AND ELECTRONIC DEVICE FOR TRANSMITTING LIVE BROADCAST DATA

(71) Applicants: Le Holdings (Beijing) Co., Ltd., Beijing (CN); LeCloud Computing Co., Ltd., Beijing (CN)

(72) Inventors: Fengyu Liu, Beijing (CN); Wei Wei, Beijing (CN); Zhengyu Lin, Beijing (CN)

(21) Appl. No.: 15/246,428

(22) Filed: Aug. 24, 2016

Related U.S. Application Data
(63) Continuation of application No. PCT/CN2016/088872, filed on Jul. 6, 2016.

(30) Foreign Application Priority Data
Dec. 15, 2015 (CN) 201510937789.8

(51) Int. Cl. H04N 21/2187; H04N 21/2387; H04N 21/258; H04N 21/44; H04N 21/472; H04N 21/234; H04N 21/61

(52) U.S. Cl. CPC H04N 21/2187; H04N 21/234; H04N 21/2387; H04N 21/6125; H04N 21/6175; H04N 21/44; H04N 21/47217; H04N 21/25841

(57) ABSTRACT

Disclosed are a method and an electronic device for transmitting live broadcast data. The technical solution of the method includes: acquiring location information of a client sending a request for playing live broadcast data; determining whether requested live broadcast data exist in a source server, wherein a distance between the location information and the source server is less than a preset threshold; and instructing the source server to feed back the live broadcast data to the client if the live broadcast data exist.

### CROSS REFERENCE TO RELATED APPLICATIONS

This application is a continuation of International Application No. PCT/CN2016/088872, filed on Jul. 6, 2016, which is based upon and claims priority to Chinese Patent Application No. 201510937789.8, filed on Dec. 15, 2015, the entire contents of all of which are incorporated herein by reference.

### TECHNICAL FIELD

The present disclosure relates to video technologies, and more particularly, to a method and an electronic device for transmitting live broadcast data.

### BACKGROUND

A cloud live broadcast system may play live broadcast data uploaded at different sites for users using the cloud live broadcast system across the globe so that users at different sites across the globe may online watch the live broadcast data. For example, after American users upload a section of live video, users in Asia may online watch this section of video.

At present, when users in different countries watch live broadcast data from a certain country through global network broadcast, because of a longer transmission distance, it is required to acquire the live broadcast data from transnational source servers for the users through Dedicated Internet Access or satellite technologies. However, since cost produced by downloading live broadcast data through Dedicated Internet Access or satellite technologies is quite expensive, and Dedicated Internet Access or satellites are not configured for all countries or states, which may cause a poorer effect in playing live broadcast data across the globe and a higher playback cost.

### SUMMARY

The present disclosure provides a method and an electronic device for transmitting live broadcast data to solve a problem in the prior art that transmitting live broadcast data among different countries or states is higher in cost.

In a first aspect, embodiments of the present disclosure provide a method for transmitting live broadcast data, implemented by a server, including:

acquiring location information of a client sending a request for playing live broadcast data;

determining whether requested live broadcast data exist in a source server, where a distance between the location information and the source server is less than a preset threshold; and

instructing the source server to feed back the live broadcast data to the client if the live broadcast data exist.

In a second aspect, embodiments of the present disclosure provide a non-transitory computer-readable storage medium storing executable instructions, wherein the executable instructions are configured to perform any methods for transmitting live broadcast data mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for transmitting live broadcast data mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for transmitting live broadcast data in accordance with some embodiments;

FIG. 2 is a flow chart of another method for transmitting live broadcast data in accordance with some embodiments;

FIG. 3 is a schematic structural diagram of a device for transmitting live broadcast data in accordance with some embodiments;

FIG. 4 is a schematic structural diagram of another device for transmitting live broadcast data in accordance with some embodiments; and

FIG. 5 is a block diagram of an electronic device which is configured to perform the methods for transmitting live broadcast data in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

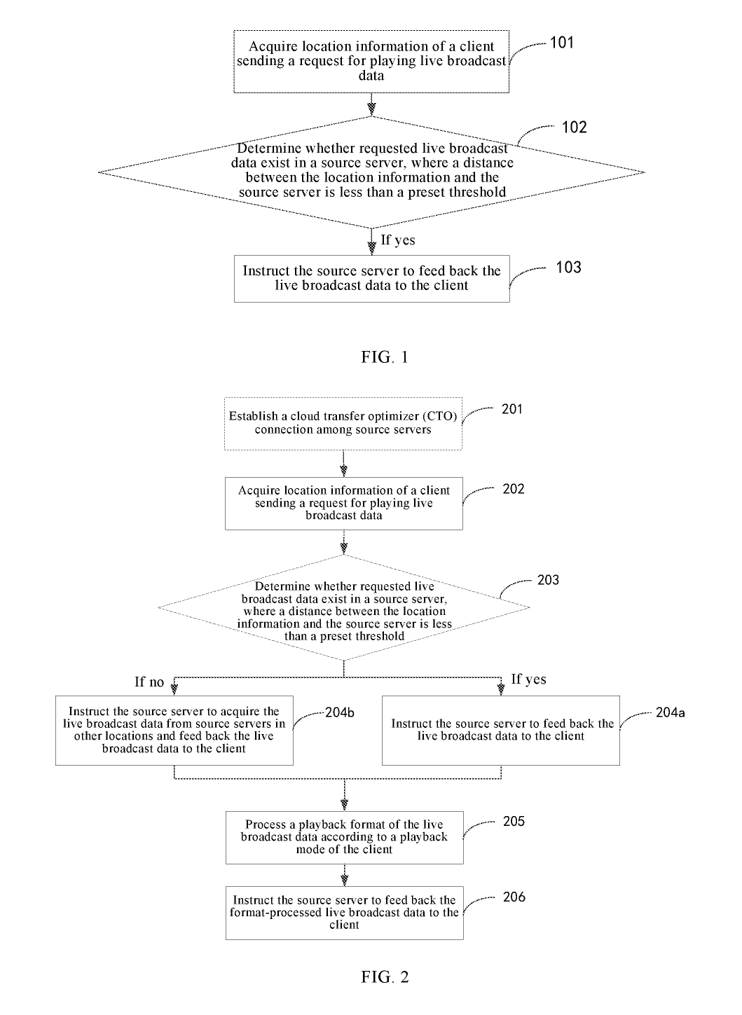

Embodiments of the present disclosure provide a method for transmitting live broadcast data, as shown in FIG. 1, the method includes following steps.

101: Location information of a client sending a request for playing live broadcast data is acquired.

The to-be-played live broadcast data can be media stream data such as video stream data and audio stream data. The location information takes a country or state as a unit, for example, Chine, the United States, America or Asia, which is not specifically limited in the embodiments of the present disclosure. A location of the client sending a request for playing live broadcast data is included in the location information. For example, if a user 1 sends a request for playing video stream data from a client in Shanghai, a user 2 sends a request for playing video stream data from a client in Beijing, and a user 3 sends a request for playing video stream data from a client in Tokyo, it is acquired that location information of the user 1 and the user 2 is China, and location information of the user 3 is Japan.

102: It is determined whether requested live broadcast data exist in a source server, where a distance between the location information and the source server is less than a preset threshold.

The preset threshold may be 10 kilometers, 100 kilometers and so on, which is not specifically limited in the embodiments of the present disclosure. The source server can save live broadcast data requested to play by different clients. For example, if the preset threshold is 100 kilometers and the location information is China, it is determined whether requested live broadcast data exist in source servers less than 100 kilometers from China.

103: The source server is instructed to feed back the live broadcast data to the client when it is determined that the requested live broadcast data exist in the source server, where the distance between the location information and the source server is less than the preset threshold.

Source servers in other locations means that each country or each state corresponds to one source server, and the source server is a source server corresponding to the location information of the client sending a request for playing live broadcast data. For example, if video stream data requested to play exist in source servers in countries such as Japan and Burma less than 100 kilometers from China, the source server in Japan or the source server in Burma is instructed to feed back the live broadcast data to China.

To the embodiments of the present disclosure, a specific application scenario can be show as below, including but not limited to: a user 1 sends a request for playing video data from a client in Shanghai, a user 2 sends a request for playing video data from a client in Tokyo, it is acquired that geographical location information of the user 1 is China and geographical location information of the user 2 is Japan, the preset threshold is 20 kilometers, if it is determined that the requested video data exist in a source server in Mongolia that is less than 50 kilometers from China and that no requested video data exists in a source server in South Korea that is less than 50 kilometers from Japan, the source server in Mongolia is instructed to feed back the live broadcast data to the client in Shanghai, and the source server in Japan acquires the video data from source servers in other countries.

According to a method for transmitting live broadcast data provided by embodiments of the present disclosure, first of all, location information of a client sending a request for playing live broadcast data is acquired, then it is determined whether requested live broadcast data exist in a source server, where a distance between the location information and the source server is less than a preset threshold, and the source server is instructed to feed back the live broadcast data to the client if the live broadcast data exist. Compared with a fact that at present when users in different countries watch live broadcast data from a certain country through global network broadcast, because of a longer transmission distance, it is required to acquire the live broadcast data from transnational source servers for the users through Dedicated Internet Access or satellite technologies, in the present disclosure, a source server having a minimum distance from a client sending a live broadcast data request is selected, and live broadcast data are acquired by means of the source server having a minimum distance and fed back to the client, which can avoid acquiring the live broadcast data from transnational source servers for the users through Dedicated Internet Access or satellite technologies, thereby reducing a playback cost and improving an efficiency in using a cloud live broadcast system.

Embodiments of the present disclosure provide another method for transmitting live broadcast data, as shown in FIG. 2, the method includes following steps.

201: A cloud transfer optimizer (CTO) connection among source servers is established.

The cloud transfer optimizer (CTO) is a technology in which link capacity is utilized fully, where the link can be directly connected between two source servers. Direct connection between servers can be implemented by establishing the CTO connection without Internet Web Site Interaction, thereby improving a transmission efficiency of live broadcast data.

202: Location information of a client sending a request for playing live broadcast data is acquired.

The to-be-played live broadcast data can be media stream data such as video stream data and audio stream data. The location information takes a country or state as a unit, for example Chine, the United States, America or Asia, which is not specifically limited in the embodiments of the present disclosure. A location of the client sending a request for playing live broadcast data is included in the location information.

203: It is determined whether requested live broadcast data exist in a source server, where a distance between the location information and the source server is less than a preset threshold.

The preset threshold may be 10 kilometers, 100 kilometers and so on, which is not specifically limited in the embodiments of the present disclosure. The source server can save live broadcast data requested to play by different clients.

204a: The source server is instructed to feed back the live broadcast data to the client when it is determined that the requested live broadcast data exist in the source server, where the distance between the location information and the source server is less than the preset threshold.

Source servers in other locations means that each country or each state corresponds to one source server, and the source server is a source server corresponding to the location information of the client sending a request for playing live broadcast data.

Further, in Step 205b in parallel with Step 205a, the source server is instructed to acquire the live broadcast data from source servers in other locations and feed back the live broadcast data to the client when it is determined that the requested live broadcast data do not exist in the source server, where the distance between the location information and the source server is less than the preset threshold. By acquiring the live broadcast data from source servers in other locations, it is avoided that the live broadcast data cannot be acquired since the live broadcast data do not exist within a preset geographical location range, thereby improving a transmission efficiency of the live broadcast data.

To the embodiments of the present disclosure, Step 205b specifically can be as below: if multiple source servers exist and the live broadcast data exist in each of the source servers, where the distance between the location information and each of the source servers is less than the preset threshold, a source server having a minimum distance is selected from the multiple source servers and the source server having a minimum distance is instructed to feed back the live broadcast data to the client. For example, among source servers less than 100 kilometers from China, if source servers in which the live broadcast data exist include a Japan source server, a Thailand source server and a Burma source server, the nearest Burma source server is selected to transmit the live broadcast data. By selecting a source server having the minimum distance, it is avoided delay in playing live broadcast data due to a longer distance, thereby improving a transmission efficiency of the live broadcast data.

206: A playback format of the live broadcast data is processed according to a playback mode of the client.

The playback mode includes playback modes of different players, and the processing a playback format may include processing different streaming media data to match with playback modes of different players. The playback format of the live broadcast data is processed so that the live broadcast data in the source server can be sent to different servers of different players, thereby improving an efficiency in playing the live broadcast data for the cloud live broadcast system.

207: The source server is instructed to feed back the live broadcast data through the CTO connection.

To the embodiments of the present disclosure, live broadcast data are acquired from source servers in other locations through the CTO connection, which not only avoids using Dedicated Internet Access or satellite transmission, but also avoids transmitting live broadcast data by means of multiple source servers, thereby improving the transmission efficiency of the live broadcast data.

To the embodiments of the present disclosure, Step 207 specifically can be as below: the source server is instructed to feed back the format-processed live broadcast data to the client. By feeding back the format-processed live broadcast data to the client, directly playing the live broadcast data can be implemented for different players of different servers, thereby improving the transmission efficiency of the live broadcast data.

To the embodiments of the present disclosure, a specific application scenario can be show as below, including but not limited to: a CTO connection is respectively established between every two source servers among source servers in America, Asia, Europe and Africa, it is acquired that clients of Asia and South America are requests for playing live broadcast data sent by a user 1 and a user 2 respectively, the preset threshold is 3,000 kilometers, it is determined that source servers less than 3,000 kilometers from an Asia source server are a Europe source server and an Africa source server and live broadcast data exit in the Europe source server and the Africa source server, the closer Europe source server is selected and instructed to feed back the live broadcast data to the Asia source server; after the Asia source server processes a playback mode of the live broadcast data, live broadcast data matched with a playback format of the user 1 are fed back to the client of the user 1, it is determined that a source server less than 3,000 kilometers from a South America source server is an North America source server, however, the North America source server has no to-be-played live broadcast data, the nearer Africa source server is instructed to feed back the live broadcast data to the South America source server, and live broadcast data matched with a playback format of the user 2 are fed back to the client of the user 2 after the South America source server processes a playback mode of the live broadcast data.

According to another method for transmitting live broadcast data provided by embodiments of the present disclosure, first of all, location information of a client sending a request for playing live broadcast data is acquired, then it is determined whether requested live broadcast data exist in a source server, where a distance between the location information and the source server is less than a preset threshold, and the source server is instructed to feed back the live broadcast data to the client if the live broadcast data exist. Compared with a fact that at present when users in different countries watch live broadcast data from a certain country through global network broadcast, because of a longer transmission distance, it is required to acquire the live broadcast data from transnational source servers for the users through Dedicated Internet Access or satellite technologies, in the present disclosure, a source server having a minimum distance from a client sending a live broadcast data request is selected, and live broadcast data are acquired by means of the source server having a minimum distance and fed back to the client, which can avoid acquiring the live broadcast data from transnational source servers for the users through Dedicated Internet Access or satellite technologies, thereby reducing a playback cost and improving an efficiency in using a cloud live broadcast system.

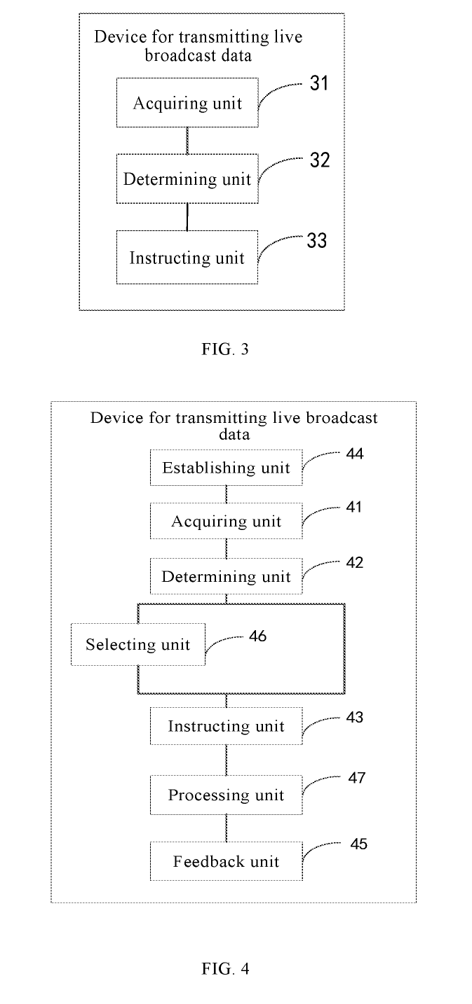

Further, as a concrete implementation of the method as shown in FIG. 1, embodiments of the present disclosure provide a device for transmitting live broadcast data, as shown in FIG. 3, the device includes: an acquiring unit 31, a determining unit 32 and an instructing unit 33.

The acquiring unit 31 is configured to acquire location information of a client sending a request for playing live broadcast data.

The determining unit 32 is configured to determine whether requested live broadcast data exist in a source server, where a distance between the location information and the source server is less than a preset threshold.

The instructing unit 33 is configured to instruct the source server to feed back the live broadcast data to the client when the determining unit 32 determines that the requested live broadcast data exist in the source server, where the distance between the location information and the source server is less than the preset threshold.

It is to be noted that reference can be made to corresponding description of the method as shown in FIG. 1 for other corresponding description of various functional units involved with a device for transmitting live broadcast data provided by the embodiments of the present disclosure, which is not unnecessarily elaborated any more herein.

According to a device for transmitting live broadcast data provided by embodiments of the present disclosure, first of all, location information of a client sending a request for playing live broadcast data is acquired, then it is determined whether requested live broadcast data exist in a source server, where a distance between the location information and the source server is less than a preset threshold, and the source server is instructed to feed back the live broadcast data to the client if the live broadcast data exist. Compared with a fact that at present when users in different countries watch live broadcast data from a certain country through global network broadcast, because of a longer transmission distance, it is required to acquire the live broadcast data from transnational source servers for the users through Dedicated Internet Access or satellite technologies, in the present disclosure, a source server having a minimum distance from a client sending a live broadcast data request is selected, and live broadcast data are acquired by means of the source server having a minimum distance and fed back to the client, which can avoid acquiring the live broadcast data from transnational source servers for the users through Dedicated Internet Access or satellite technologies, thereby reducing a playback cost and improving an efficiency in using a cloud live broadcast system.

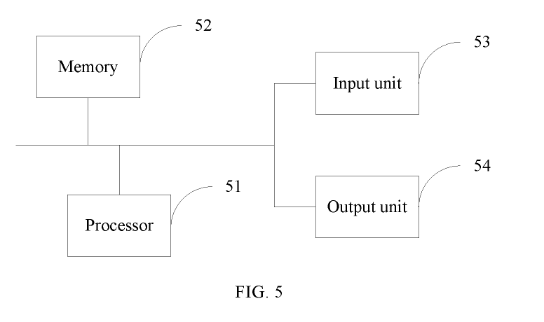

Further, as a concrete implementation of the method as shown in FIG. 2, embodiments of the present disclosure provide another device for transmitting live broadcast data, as shown in FIG. 4, the device includes: an acquiring unit 41, a determining unit 42, an instructing unit 43, an establishing unit 44, a feedback unit 45, a selecting unit 46 and a processing unit 47.

The acquiring unit 41 is configured to acquire location information of a client sending a request for playing live broadcast data.

The determining unit 42 is configured to determine whether requested live broadcast data exist in a source server, where a distance between the location information and the source server is less than a preset threshold.

The instructing unit 43 is configured to instruct the source server to feed back the live broadcast data to the client when the determining unit 42 determines that the requested live broadcast data exist in the source server, where the distance between the location information and the source server is less than the preset threshold.

The instructing unit 43 is further configured to instruct the source server to acquire the live broadcast data from source servers in other locations and feed back the live broadcast data to the client when the determining unit 42 determines that the requested live broadcast data do not exist, where the distance between the location information and the source server is less than the preset threshold.

Further, the device further includes:

an establishing unit 44, configured to establish a cloud transfer optimizer (CTO) connection among source servers; and

a feedback unit 45, further configured to instruct the source server to feed back the live broadcast data through the CTO connection.

Further, the device further includes: a selecting unit 46 and a processing unit 47.

The selecting unit 46 is configured to select a source server having a minimum distance from multiple source servers and instruct the source server having a minimum distance to feed back the live broadcast data to the client if the multiple source servers exist, where a distance between the location information and each of the source servers is less than a preset threshold and the live broadcast data exist in each of the source servers.

The processing unit 47 is configured to process a playback format of the live broadcast data according to a playback mode of the client.

The feedback unit 45 is specifically configured to instruct the source server to feed back the format-processed live broadcast data to the client.

It is to be noted that reference can be made to corresponding description of the method as shown in FIG. 2 for other corresponding description of various functional units involved with another device for transmitting live broadcast data provided by the embodiments of the present disclosure, which is not unnecessarily elaborated any more herein.

According to another device for transmitting live broadcast data provided by embodiments of the present disclosure, first of all, location information of a client sending a request for playing live broadcast data is acquired, then it is determined whether requested live broadcast data exist in a source server, where a distance between the location information and the source server is less than a preset threshold, and the source server is instructed to feed back the live broadcast data to the client if the live broadcast data exist. Compared with a fact that at present when users in different countries watch live broadcast data from a certain country through global network broadcast, because of a longer transmission distance, it is required to acquire the live broadcast data from transnational source servers for the users through Dedicated Internet Access or satellite technologies, in the present disclosure, a source server having a minimum distance from a client sending a live broadcast data request is selected, and live broadcast data are acquired by means of the source server having a minimum distance and fed back to the client, which can avoid acquiring the live broadcast data from transnational source servers for the users through Dedicated Internet Access or satellite technologies, thereby reducing a playback cost and improving an efficiency in using a cloud live broadcast system.

Further, an embodiment of the present disclosure further provides a non-transitory computer-readable storage medium storing executable instructions, which can be executed by an electronic device to perform any methods for transmitting live broadcast data mentioned by embodiments of the present disclosure.

FIG. 5 is a block diagram of an electronic device which is configured to perform the methods for transmitting live broadcast data according to an embodiment of the present disclosure. As shown in FIG. 5, the device includes:

one or more processors 51 and memory 52. A processor 51 is showed in FIG. 5 for an example.

Device which is configured to perform the methods for transmitting live broadcast data can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for transmitting live broadcast data mentioned by embodiments of the present disclosure (such as shown in FIG. 3, acquiring unit 31, determining unit 32 and instructing unit 33). Processor 51 performs kinds of functions and transmitting live broadcast data of the electronic device by executing non-transitory software program, instructions and modules which are stored in memory 52, thereby realizes the methods for transmitting live broadcast data mentioned by embodiments of the present disclosure.

Memory 52 can include program storage area and data storage area, thereby the operating system and applications required by at least one function can be stored in program storage area and data created by using the device for transmitting live broadcast data can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for transmitting live broadcast data by networks. The examples of said networks are including but not limited to Internet, Intranet, LAN, mobile Internet and their combinations.

Input unit 53 can be used to receive inputted number, character information and key signals causing user configures and function controls of the device for transmitting live broadcast data. Output unit 54 can include a display screen or a display device.

The said module or modules are stored in memory 52 and perform the methods for transmitting live broadcast data when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for transmitting live broadcast data, implemented by a server, comprising:
acquiring location information of a client sending a request for playing live broadcast data;
determining whether requested live broadcast data exist in a source server, wherein a distance between the location information and the source server is less than a preset threshold; and
instructing the source server to feed back the live broadcast data to the client if the live broadcast data exist.

2. The method for transmitting live broadcast data according to claim 1, further comprising:
instructing the source server to acquire the live broadcast data from source servers in other locations and feeding back the live broadcast data to the client if the live broadcast data do not exist.

3. The method for transmitting live broadcast data according to claim 1, comprising:
establishing a cloud transfer optimizer (CTO) connection among source servers; and
instructing the source server to feed back the live broadcast data through the CTO connection.

4. The method for transmitting live broadcast data according to claim 1, comprising:
selecting a source server having a minimum distance from multiple source servers and instructing the source server having a minimum distance to feed back the live broadcast data to the client if the multiple source servers exist, if a distance between the location information and each of the source servers is less than a preset threshold and the live broadcast data exist in each of the source servers.

5. The method for transmitting live broadcast data according to claim 1, further comprising:
processing a playback format of the live broadcast data according to a playback mode of the client; and
instructing the source server to feed back the format-processed live broadcast data to the client.

6. A non-transitory computer-readable storage medium storing executable instructions, wherein the executable instructions are configured to:
acquire location information of a client sending a request for playing live broadcast data;
determine whether requested live broadcast data exist in a source server, wherein a distance between the location information and the source server is less than a preset threshold; and
instruct the source server to feed back the live broadcast data to the client if the live broadcast data exist.

7. The non-transitory computer-readable storage medium according to claim 6, wherein the executable instructions are further configured to:
instruct the source server to acquire the live broadcast data from source servers in other locations and feed back the live broadcast data to the client if the live broadcast data do not exist.

8. The non-transitory computer-readable storage medium according to claim 6, wherein the executable instructions are further configured to:
establish a CTO connection among source servers; and
instruct the source server to feed back the live broadcast data through the CTO connection.

9. The non-transitory computer-readable storage medium according to claim 6, wherein the executable instructions are further configured to:
select a source server having a minimum distance from multiple source servers and instruct the source server having a minimum distance to feed back the live broadcast data to the client if the multiple source servers exist, if a distance between the location information and each of the source servers is less than a preset threshold and the live broadcast data exist in each of the source servers.

10. The non-transitory computer-readable storage medium according to claim 6, wherein the executable instructions are further configured to:
process a playback format of the live broadcast data according to a playback mode of the client; and
instruct the source server to feed back the format-processed live broadcast data to the client.

11. An electronic device, comprising:
at least one processor; and
a memory communicably connected with the at least one processor for storing instructions executable by the at least one processor, wherein execution of the instructions by the at least one processor causes the at least one processor to:
acquire location information of a client sending a request for playing live broadcast data;
determine whether requested live broadcast data exist in a source server, wherein a distance between the location information and the source server is less than a preset threshold; and
instruct the source server to feed back the live broadcast data to the client if the live broadcast data exist.

12. The electronic device according to claim 11, wherein the instructions are executed to cause the at least one processor to:
instruct the source server to acquire the live broadcast data from source servers in other locations and feed back the live broadcast data to the client if the live broadcast data do not exist.

13. The electronic device according to claim 11, wherein the instructions are executed to cause the at least one processor to:
establish a CTO connection among source servers; and
instruct the source server to feed back the live broadcast data through the CTO connection.

14. The electronic device according to claim 11, wherein the instructions are executed to cause the at least one processor to:
select a source server having a minimum distance from multiple source servers and instruct the source server having a minimum distance to feed back the live broadcast data to the client if the multiple source servers exist, if a distance between the location information and each of the source servers is less than a preset threshold and the live broadcast data exist in each of the source servers.

15. The electronic device according to claim 11, wherein the instructions are executed to cause the at least one processor to:
process a playback format of the live broadcast data according to a playback mode of the client; and
instruct the source server to feed back the format-processed live broadcast data to the client.
